(19) United States
(12) Patent Application Publication
(10) Pub. No.: US 2013/0282429 A1
(43) Pub. Date: Oct. 24, 2013

(54) APPARATUS AND METHOD FOR CONTEXT BASED ACTIVITY MODELING

(71) Applicants: Yong Se KIM, Seoul (KR); Young Kon LEE, Ansan-si (KR)

(72) Inventors: Yong Se KIM, Seoul (KR); Young Kon LEE, Ansan-si (KR)

(73) Assignee: RESEARCH & BUSINESS FOUNDATION SUNGKYUNKWAN UNIVERSITY, Suwon-si (KR)

(21) Appl. No.: 13/773,897

(22) Filed: Feb. 22, 2013

(30) Foreign Application Priority Data
Feb. 24, 2012 (KR) 10-2012-0018988

(51) Int. Cl. G06Q 30/02

(52) U.S. Cl. CPC G06Q 30/0201
USPC 705/7.29

(57) ABSTRACT

A context-based activity modeling apparatus is provided which includes an activity element input interface via which data about an activity element including one or more of activity information of an activity modeling target, activity subject information, object information, tool information, and context information are input; a data mapping unit for mapping the data input via the activity element input interface based on relations therebetween; and an activity modeling display unit that graphically displays the mapped data on a screen.

### FIELD OF THE INVENTION

The present disclosure relates to an apparatus and a method for context-based activity modeling.

### BACKGROUND OF THE INVENTION

Many companies are highly interested in shifting towards a service-oriented paradigm and creating a new business model to improve their competitiveness. They try to find comprehensive solutions to understand and satisfy consumers' needs. The center of the competitiveness of companies is shifting from physical products to people-centered services.

In order to deal with such trends, a concept of product-service system (PSS) design has been introduced which pursues that product elements and service elements are systemically integrated to deliver higher values to different stakeholders.

The PSS design is an integrated design process composed of planning, concept design, and embodiment design. The product and technical competitiveness of the given company is analyzed and restructured with innovative viewpoints of diverse values of customers.

If needed, some product and technical aspects can be outsourced to complement their own strengths. Then a new PSS where products elements and service elements are systematically combined is to be designed as well as a new business model.

Methods for integrating products elements and service elements include “servicitization of product” meaning that service elements are added to an existing product and “productization of service” meaning that physical product elements are added to an existing service. Examples of servicitization of product include a bike rental system, while examples of productization of service include an automated teller machine by which bank services are automated.

For example, the PSS may mean a service including, instead of just selling a product, renting a product to a consumer, requesting the consumer to buy a permission to use the product, and providing a follow-up management of the product or a consulting about the product. The PSS enables a company to keep paying attention to consumers and to maintain its competitiveness by integrating product elements and service elements.

However, the conventional PSS designing is very complicated in comparison to developing of a product and highly depends on the designer's sense or intuition.

In particular, a PSS designing process includes a lot of “activities” of various stakeholders. Modeling and designing such activities is important. However, conventional methods for activity design (modeling) lack detailed and clear definition about what activities are, though they also consider subjects, objects, tools, and context elements of activities. And a computer-based activity modeling and designing tool also needs to be developed.

### BRIEF SUMMARY OF THE INVENTION

In view of the foregoing, illustrative embodiments of the present disclosure provide an apparatus and a method for context-based activity modeling capable of carrying out the context-based activity modeling concretely and efficiently based on a computer system.

In accordance with an illustrative embodiment, a context-based activity modeling apparatus is provided which includes an activity element input interface via which data about an activity element including one or more of activity information of an activity modeling target, activity subject information, object information, tool information, and context information are input; a data mapping unit for mapping the data input via the activity element input interface based on relations therebetween; and an activity modeling display unit that graphically displays the mapped data on a screen.

Further, in accordance with an illustrative embodiment, a context-based activity modeling method is provided which includes storing input data about an activity element including one or more of activity information of an activity modeling target, activity subject information, object information, tool information, and context information; mapping the stored data based on relations therebetween; and displaying graphically the mapped data on a screen.

In accordance with one of the illustrative embodiments, it is possible to carry out context-based activity modeling based on a computer in more detail with more efficiency.

In particular, one aspect of the present inventive concept can define and express an activity in more detail by inputting data for an activity element that includes one or more of information including an activity of a modeling target, activity subject information, object information, tool information, and context information, mapping the data based on the information about the context, and visually displaying the data.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 illustrates a conventional scenario of an experience of donating used clothes in a specific context suggested as an example for explaining a PSS design process in accordance with an illustrative embodiment;

FIG. 2 illustrates a new scenario of a clothing donation bins PSS;

FIG. 3 shows an E3 value-based value system in accordance with an illustrative embodiment;

FIG. 4 provides a service blueprint for activity modeling of stakeholders in general where activities of a stakeholder are represented in sequence together with their relation with other activities;

FIG. 5 illustrates an activity modeling in accordance with an illustrative embodiment;

FIG. 6 illustrates an activity element input interface in accordance with an illustrative embodiment;

FIG. 7 illustrates an activity modeling which can be input through the activity element input interface in accordance with an illustrative embodiment;

FIGS. 8 to 10 are provided to explain a context information management method in accordance with an illustrative embodiment;

FIG. 11 illustrates a PSS activity modeling apparatus in accordance with an illustrative embodiment;

FIG. 12 illustrates a PSS activity modeling method in accordance with an illustrative embodiment; and

FIG. 13 illustrates a scenario generation template in accordance with an illustrative embodiment so that those activities selected would be represented in the service blueprint.

### DETAILED DESCRIPTION OF THE INVENTION

Hereinafter, examples of the present disclosure will be described in detail with reference to the accompanying drawings so that the present disclosure may be readily implemented by those skilled in the art. However, it is to be noted that the present disclosure is not limited to the embodiments but can be embodied in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements unless context dictates otherwise.

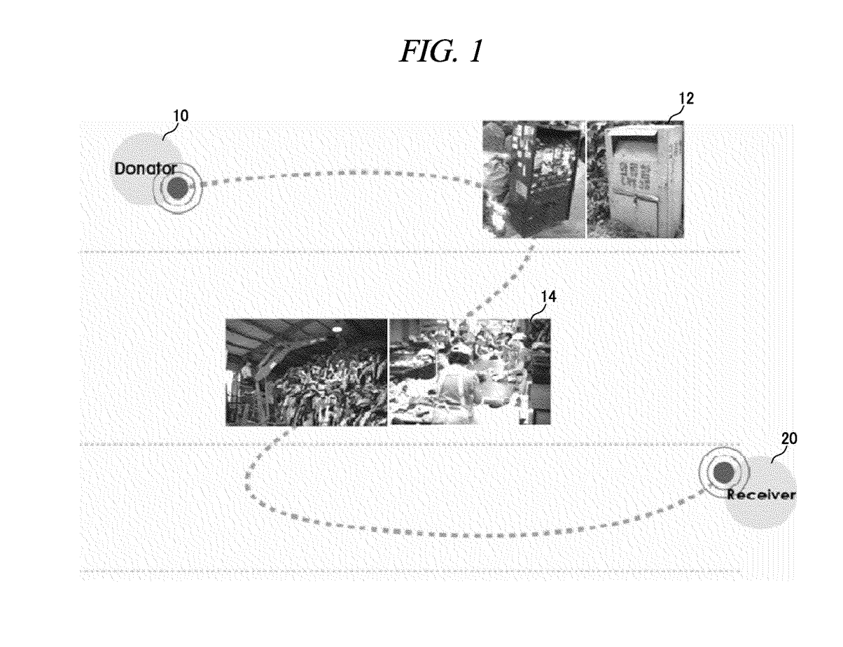

FIG. 1 illustrates a scenario of a conventional experience in used clothes donation suggested as an example for explaining a PSS design process in accordance with an illustrative embodiment.

By way of example, suppose there is a recycling service of used clothes providing a used clothing donation bin 12 (product) located in a shabby corner of a back alley street in town. And suppose on a rainy night, there is a clothing donator 10 who wants to donate his/her used clothes into the used clothing donation bin 12 located in the shabby corner of the back alley street and there are stray cats prowling around the used clothing donation bin 12.

In above-described contexts, negative reactive emotional experience values may be obtained from the used clothing donation bin 12. And poor physical contexts may reduce active emotional experience values needed for voluntary donation of clothes. The clothes collected from the used clothing donation bin 12 may be treated like trashes and only a few useful clothes may be selected by laborious efforts of human operators 14. Once the negative values encountered in the shabby used clothing donation bin are identified, designing a product-service system (hereinafter, referred to as “PSS”) can be launched to convert the negative experience values into positive ones.

A new PSS concept for improving experience values of the clothing donator 10 and a receiver 20 is created by designing activities. By way of example, Installing a used clothing donation bin at a community center or a convenience store in town may lead up to a variety of new activities of the clothing donator 10. That is, by changing the physical contexts, a new service activity for improving a specific target value can be created effectively.

By way of example, an activity and an attribute similar to and relevant to giving used clothes of his/her son to his/her nephew as a present may be created in the new concept. Further, an activity of packaging clothes may be added to the clothing donator 10. Furthermore, activities of the clothing donator 10 such as even repairing and cleaning used clothes may be added to the new concept.

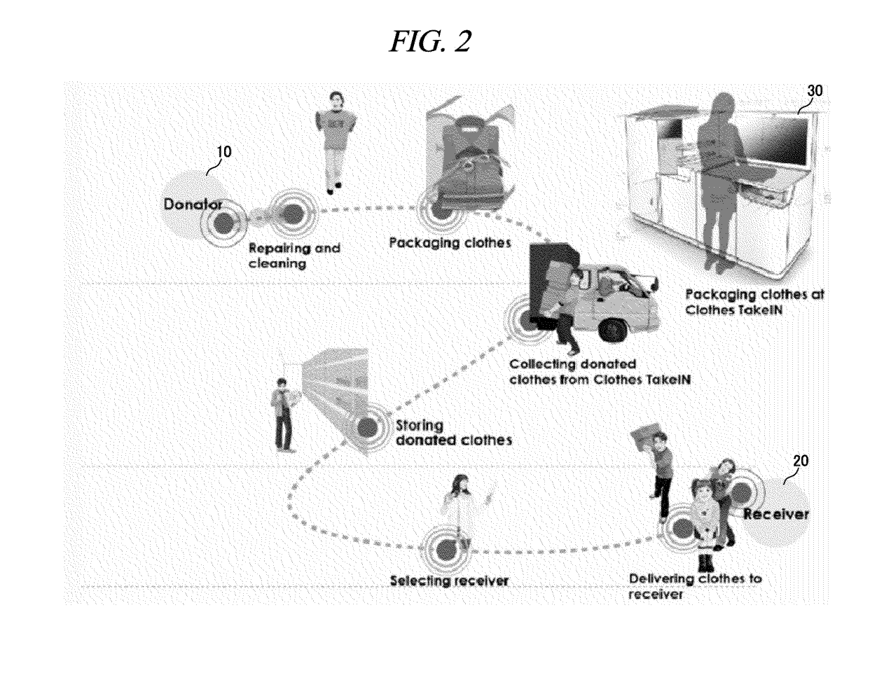

FIG. 2 illustrates a scenario of a new used clothing donation PSS based on FIG. 1.

The activities added into the new concept are mapped (or associated) to functions (sub-functions) divided from an overall function (super-function) of “collecting and supplying clothes”. Such relations between activities and functions are displayed on a function-associated service blueprint. Functional requisites or requirements for specific activities can be recognized as characteristics of a prototype. An activity of inputting information of the clothes may be carried out through a small screen provided at a left upper end of the used clothing donation PSS station 30. The clothes may be pictured by a camera provided at an upper end of a large screen, and guidelines for packaging the clothes may be displayed on the large screen.

The clothing donator 10 can use a proper packaging box supplied by a box supply module of the station 30. Then, the clothing donator 10 can print out a barcode sticker containing information of the donated clothes and attaches the barcode sticker to the box. And then, the box can be put into an input slot that has a barcode scanning module and stored in a storage unit provided at a lower side of the station 30.

The used clothing donation PSS station 30 can be designed with a prototype including activity-motivating characteristics. For example, a left upper plate of the station 30 may be designed with an appropriate height and shape so that the clothing donator 10 can put his/her belongings such as a bag thereon.

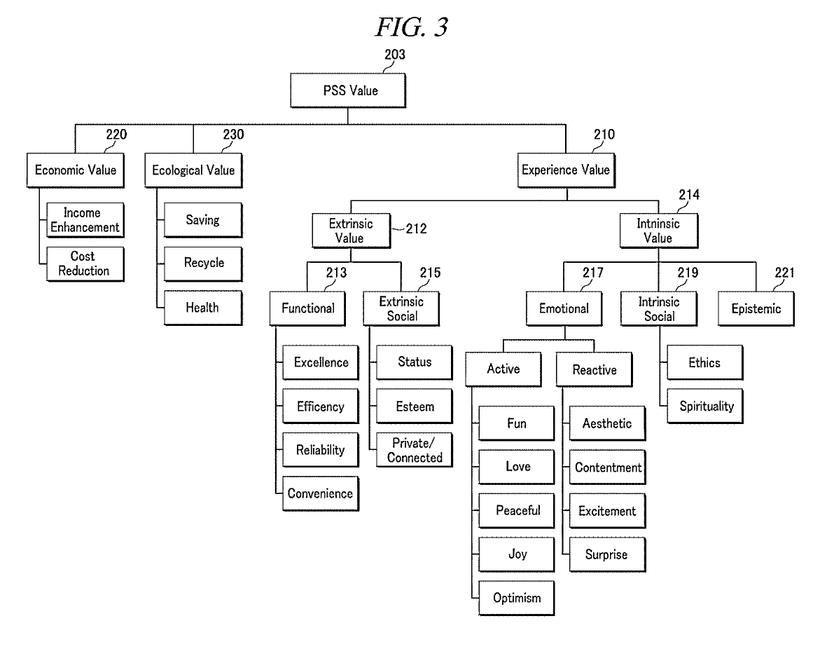

Now, based on the above-described example of a used clothing donation PSS, a PSS design method in accordance with an illustrative embodiment of the present inventive concept will be described with reference to the accompanying drawings (FIGS. 3 to 16). The PSS design methods are not limited to the provided example and can be applied to various kinds of PSS designs. In particular, a PSS design can be achieved more clearly and specifically with an activity modeling apparatus 100 to be described below.

FIG. 3 shows an E3 value-based value system in accordance with an illustrative embodiment.

As depicted in FIG. 3, values regarded as important by respective stakeholders are analyzed, and in order to more expansively improve these values, a target value can be defined by mutually mapping the above-described requirements to a value element 203. Herein, the value element 203 includes one or more of an experience value 210, an economic value 220, and an ecological value 230 (also referred to as “E3 values”)

By way of example, the experience value 210 consists of an extrinsic value 212 and an intrinsic value 214. The extrinsic value 212 is related to a functional value 213 and an extrinsic social value 215. The intrinsic value 214 includes an emotional value 217 having self-motivated and reactive aspects, an intrinsic social value 219, and an epistemic value 221. The experience value 210 can be explained with the above-described example of the used clothing donation bin. The reactive emotion one might feel when approaching a used clothing donation bin which can be misrecognized as a dirty or smelly trash bin has a negative effect on making more people use the donation bin.

On the contrary, a young mother who donates baby clothes with the hope that a baby as cute as hers will put on the used clothes may feel an active emotion. Further, if a donation record is notified to a housewife who donates a lot of clothes, an extrinsic social value is offered to her. Thus, via a process of finding values which the current used clothing donation bins cannot offer by mapping the above-described requirements to the value element 203, a target value can be defined.

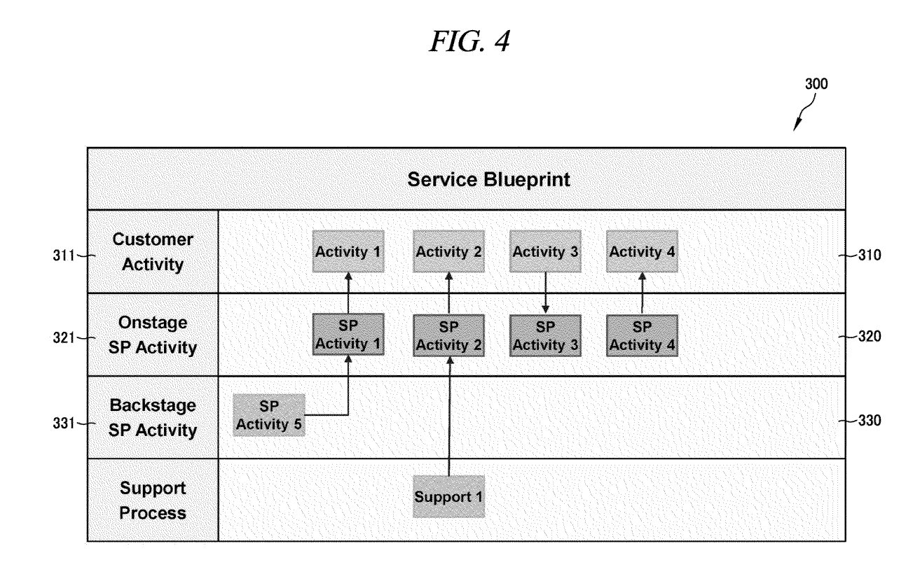

FIG. 4 provides a service blueprint for activity modeling of stakeholders in accordance with an illustrative embodiment.

As depicted in FIG. 4, a service blueprint 300 showing activity modeling of stakeholders may be comprised of a service receiver (SR) layer 310 and service provider (SP) layers 320 and 330. The service provider layer may be comprised of an onstage service provider layer 320 which is in direct contact with a service receiver and a backstage service provider layer 330 which is not in direct contact with the service receiver. Further, a support process layer may be added thereto. With the service blueprint 300 in which activities of stakeholders are defined and classified and relations between the activities (information) are analyzed and displayed, activity modeling can be carried out based on the relations between the activities of the stakeholders.

By way of example, the stakeholders can be classified into the service receiver and the service provider. Activities of the stakeholders are defined and displayed in time series on the service blueprint 300. A relation between the respective activities is visually listed on the service blueprint 300 based on a relation caused by an interaction between activities of the service receiver and the service provider.

By way of example, a service receiver activity 311 including having clothes repair or clean has a relation, due to interactions between activities, with an onstage service provider activity 321 including checking clothes to be repaired or cleaned and a backstage service provider activity 331 including repairing or cleaning the clothes. Such relations are visually listed on the service blueprint 300.

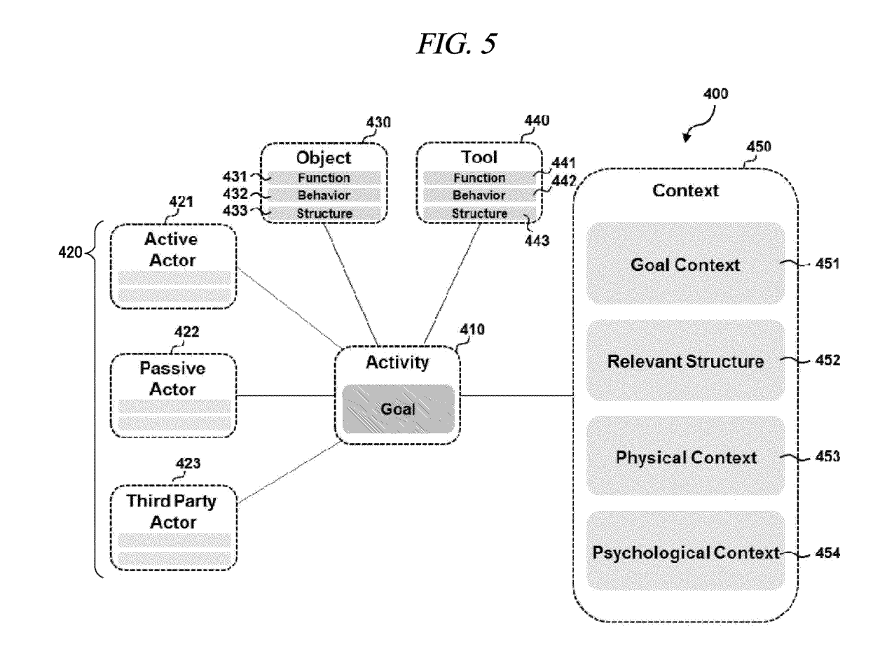

Thus, activity modeling of the stakeholders can be carried out based on the relations between the respective activities of the stakeholders as displayed on the service blueprint 300. Further, the activities of the stakeholders can be more specified through activity modeling 400 to be carried out based on context information as shown in FIG. 5.

FIG. 5 illustrates activity modeling in accordance with an illustrative embodiment.

As depicted in FIG. 5, the activities of the stakeholders can be more specified based on an activity element including an activity 410, an activity subject 420, an object 430, a tool 440, and context information 450.

The activity 410 may include a goal, and the activity subject 420 may include an active actor 421, a passive actor 422, and a third party actor 423. The object as a target of the activity may include a function 431, a behavior 432, and a structure 433, and the tool 440 as a means for achieving the goal may include a function 441, a behavior 442, and a structure 443.

By way of example, suppose a housewife donator approaching a used clothing donation bin with a goal to donate used clothes with a physical contexts 453 that it is rainy and a location of the clothes bin is in a secluded corner of a back alley and with a psychological context 454 that she feels unsafe walking alone. Under these contexts, experience values the donation activity gives might not very positive. However, by replacing some elements of these contexts, a positive experience can be achieved.

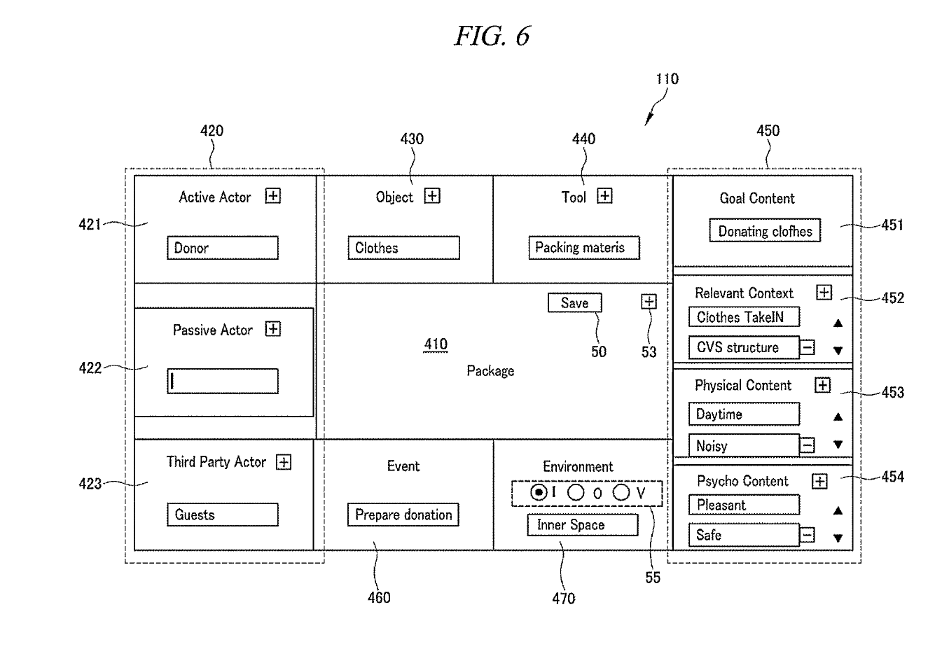

FIG. 6 illustrates an activity element input interface in accordance with an illustrative embodiment.

As depicted in FIG. 6, data about an activity element including one or more of activity information of an activity modeling target, activity subject information, object information, tool information, and context information can be input through an activity element input interface 110.

The activity element input interface 110 includes an activity input module 410 for inputting a goal element (information), an activity subject input module 420 for inputting activity subject information, an object input module 430 for inputting object information, a tool input module 440 for inputting tool information, and a context input module 450 for inputting context information. Further, the activity element input interface 110 may include an event input module 460 for inputting event information and an environment input module 470 for inputting environment information.

By way of example, via the activity element input interface 110, “Package” may be input into a field representing the goal information of the target of the activity modeling. Like so, “Donor” via an active actor input module 421 of the activity subject input module 420, “Receiver” via a passive actor input module 422, and “Guest” via a third party actor input module 423 may be input.

“Clothes” as an object of the activity via the object input module 430, “Packaging material” as a means for achieving the goal of the target of activity modeling via the tool input module 440, “Donating clothes” via a goal context input module 451 of the context input module 450, “Clothes TakeIN/CVS Structure” via a relevant structure context input module 452, “Daytime/Noisy/Bright” via a physical context input module 453, and “Pleasant/Safe” via a psychological context input module 454 as respective field values may be input.

Moreover, event information and environment information may be additionally input. An event 460 causes a change of activity in various contexts 450, and an environment 470 where an activity is conducted includes an inner space, an outer space, and a virtual space.

“Prepare Donation” may be input via the event input module 460. The activity environment may be input via the environment input module 470 with an option button 55, and any one of an inner space I, an outer space O, and a virtual space V may be selected.

A user can input more detailed field values via rollout buttons 53 included in the modules of the activity element input interface 110. By way of example, if the user clicks the rollout button 53 to input detailed field values in the physical context input module 453, fields such as “Weather/Time/Location/Lighting/ . . . ” may be provided. The user can input values for each field.

If the user clicks the rollout button 53 to input detailed field values in the psychological context input module 454, fields such as “Occupant Context/Social Context/Affective Context/Cognitive Context/Motivation Context/ . . . ” can be provided. The user can input values for each field. Finally, the user may click a save button 50 and data input is completed.

As described above, the field values input through the activity element input interface 110 are mapped based on context information and visualized and displayed on a screen as illustrated in FIG. 6. Each element of FIG. 6 is filled with a data value input through each module of FIG. 6. Each element of FIG. 6 can be implemented by each module of FIG. 6, and in this case, data from each element of FIG. 5 can be input directly.

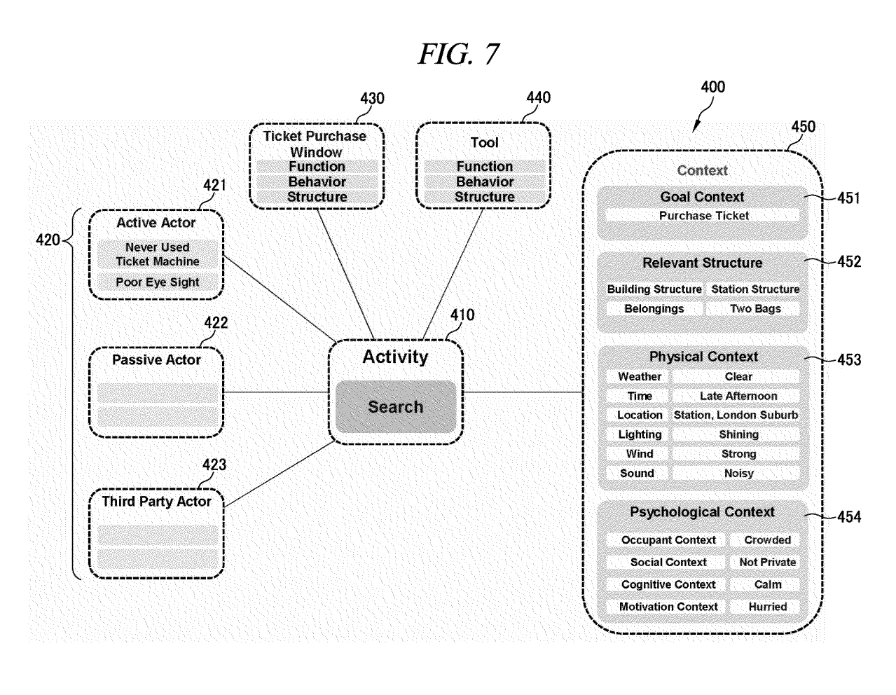

FIG. 7 illustrates activity modeling which can be input through an activity element input interface in accordance with an illustrative embodiment.

That is, a goal context, more detailed information about a relevant structure context, a physical context, and a psychological context can be input through the context input modules 451 to 454 of the activity element input interface illustrated in FIG. 6.

By way of example, in case of an activity modeling of search for a train ticket to purchase a ticket at a train station, “Purchase ticket” is input as a field value via the goal context input module 451. Further, “Station Structure” is input as a value for field “Building Structure” where an actor is located and “Two Bags” is input as a value for field “Belongings” of the actor via the relevant structure context input module 452. Furthermore, “Clear” is input as a value for field “Weather” and “Late Afternoon” is input as a value for field “Time” via the physical context input module 453. Moreover, a field “Location”, a field “Wind”, and a field “Sound” are respectively filled with proper values of contexts of the actor.

Besides, a field “Occupant Context”, a field “Social Context”, a field “Cognitive Context”, and a field “Motivation Context” are filed with respectively filled with proper values of psychological contexts of the actor via the psychological context input module 454.

Activities to be modeled may have different fields and field values that describe contexts, and different information can be stored in a storage unit 140 to be explained later.

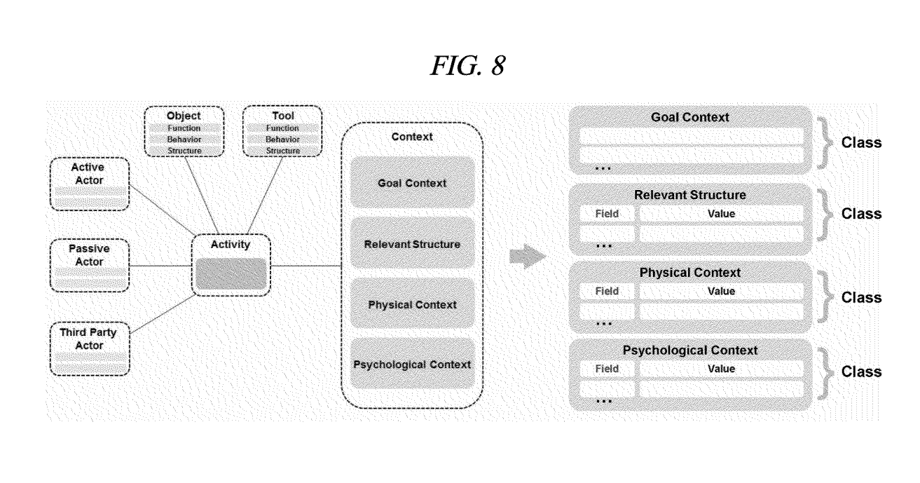

FIGS. 8 to 10 are provided to explain a context information management method in accordance with an illustrative embodiment.

Information of contexts can be described by one or more fields and field values required for describing the contexts. Elements selected by a user for describing contexts are defined as fields and can be set in various ways by the user who inputs context information.

A data structure that stores a field and a field value for describing context information is referred to as a context class. As depicted in FIG. 8, multiple context classes that store one or more fields and field values for a goal context, a relevant structure context, a physical context, and a psychological context may be defined. In an activity modeling process of a specific activity, context information can be described with one or more context classes. Fields and field values included in the context classes can be freely generated, deleted or edited by the user.

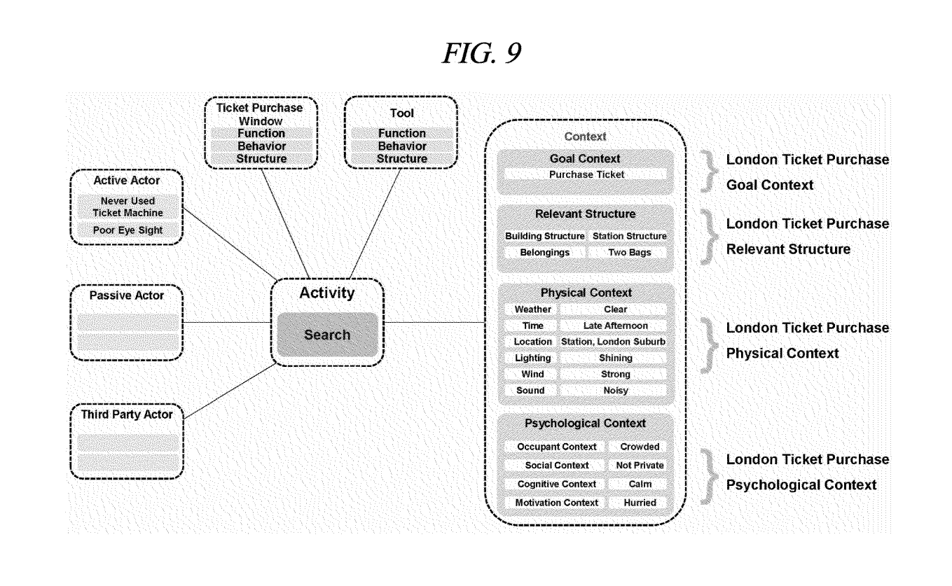

FIG. 9 is provided to explain a context class example. Multiple context classes for modeling an activity of a user who purchases a train ticket for London are generated and stored. Names of the context classes can be defined by combining a name of the activity to be modeled and names of contexts, but the present disclosure may not be limited thereto.

Such context classes for each activity can be generated and managed and can be shared between different activities during modeling processes of those activities.

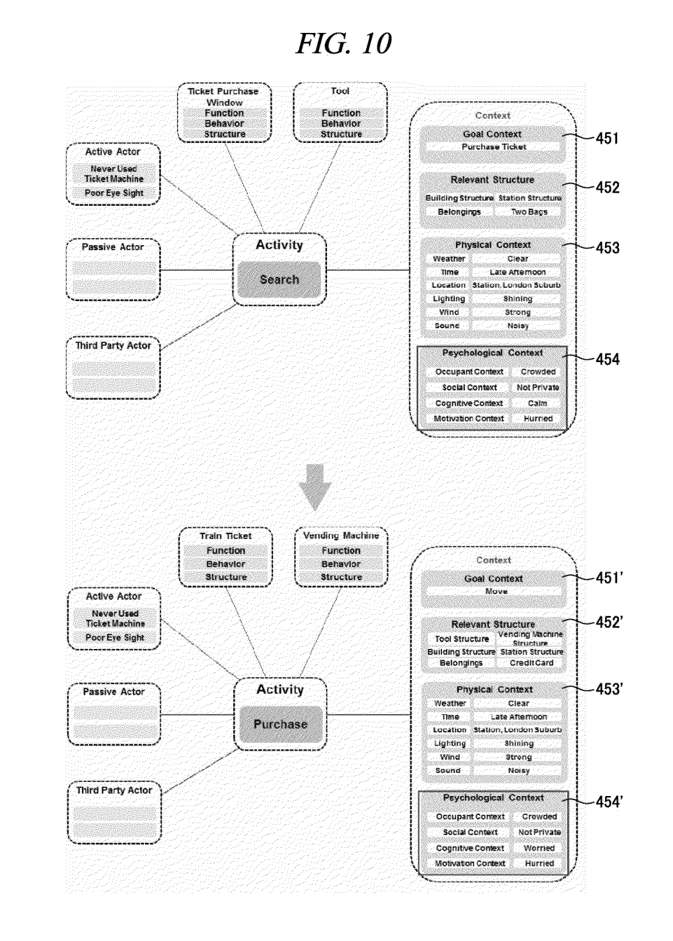

FIG. 10 illustrates an activity modeling process of each activity and also illustrates a sharing process of a context class for modeling each activity.

On the left of FIG. 10, modeling of a search activity for purchasing a train ticket is illustrated, and on the right of FIG. 10, modeling of a purchase activity of the train ticket is illustrated. These activities are carried out consecutively but different from each other. Thus, context information of each activity may be different. In some cases, a field or a field value for describing context information may be identical, and in such cases, the identical context class is shared.

By way of example, as for the relevant structure context 452, the search activity modeling and the purchase activity modeling have different fields for describing context information, and, thus, an identical context class cannot be shared.

However, as for the physical context 453, field and field values are identical, and, thus, a context class of the search activity modeling can be shared by the purchase activity modeling.

As for the psychological context 454, even if field values are somewhat different, fields are identical, and, thus, a context class of the search activity modeling can be shared by the purchase activity modeling. That is, the context class can be shared by just modifying the field values during the purchase activity modeling.

As described above, context classes can be used for describing context information for activity modeling and shared between different activity modeling processes.

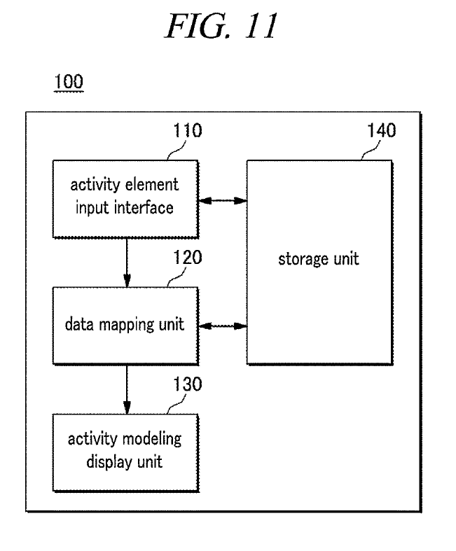

FIG. 11 illustrates a context-based activity modeling apparatus in accordance with an illustrative embodiment.

As depicted in FIG. 11, the activity modeling apparatus 100 includes the activity element input interface 110, a data mapping unit 120, an activity modeling display unit 130, and the storage unit 140. A PSS design can be achieved in more detail with more efficiency by the activity modeling apparatus 100.

The activity element input interface 110 allows data about an activity element including one or more of activity information of an activity modeling target, activity subject information, object information, tool information, and context information to be input. As described above with reference to FIG. 7, the activity element input interface 110 includes the multiple modules 410 to 450 for inputting data about the respective activity elements. Refer to FIG. 6 for more details.

The data mapping unit 120 maps the data input through the activity element input interface 110 based on mutual relations between the data. Herein, the data mapping unit 120 mutually maps the input data to each other based on context information. The context information includes one or more of a goal context, a relevant structure context, a physical context, and a psychological context as described above. By way of example, there may be a case where a goal context is “Donating Clothes”, a relevant structure context is “Clothes TakeIN”, a physical context is “Daytime/Noisy/Bright”, and a psychological context is “Pleasant/Safe”.

In this case, “Outdoors” input as environment information and “Clothes” input as object information are related to one or more of the above-described contexts and thus mapped to the contexts. Further, the environment information has a relation with the object information, and, thus, they are mapped to each other. The environment information and the object information have a relation with “Package” input as activity information, and, thus, they are mapped to each other. Thus, activity modeling can be carried out by mapping activity element input data with each other based on contexts (information).

The activity modeling display unit 130 displays the mapped data graphically on a screen. The activity modeling display unit 130 displays the respective activity elements and data corresponding thereto on the screen. The data corresponding to the activity elements may be data input through the activity element input interface 110. Refer to FIGS. 5 and 6 for more details.

The storage unit 140 stores the data of the activity elements input through the activity element input interface 110. Further, the storage unit 140 may store the mapped data, an algorithm for mapping the data, and various programs for activity modeling.

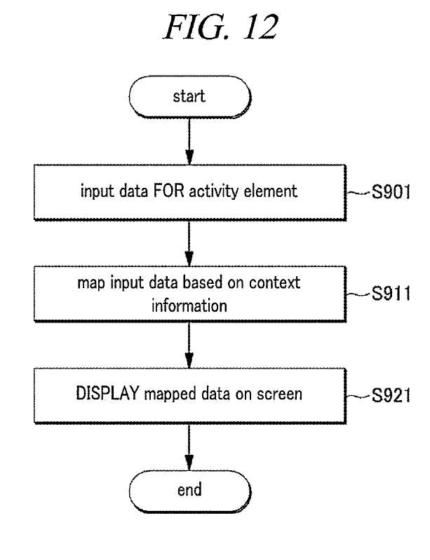

FIG. 12 illustrates a context-based activity modeling method in accordance with an illustrative embodiment.

As depicted in FIG. 12, first, data about an activity element including one or more of activity information of an activity modeling target, activity subject information, object information, tool information, and context information are input and the input data are stored (S901).

Then, the stored (input) data are mapped based on relations between the data (S911). The stored data can be mapped to each other based on context information.

Thereafter, the mapped data are graphically displayed on a screen (S921). Here, the respective activity elements and data corresponding thereto may be displayed on the screen. Refer to FIGS. 6 to 12 for more details of the above-described steps S901, S911, and S921.

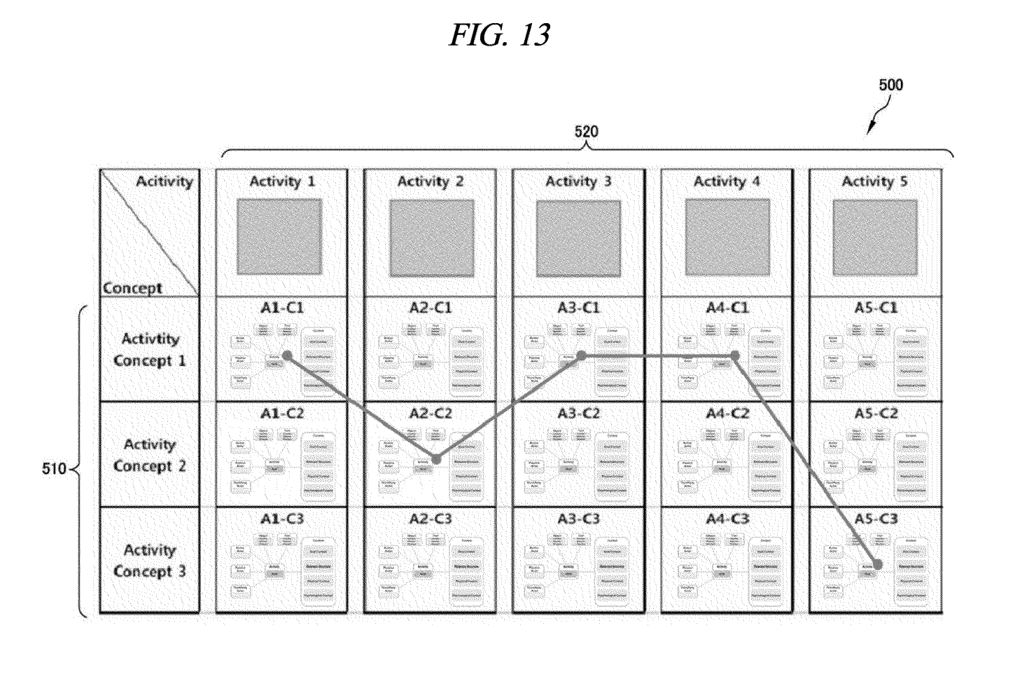

Various scenarios can be generated based on the above-described activity modeling 400, and details thereof will be explained with reference to FIG. 13.

FIG. 13 illustrates a scenario generation template in accordance with an illustrative embodiment.

As depicted in FIG. 13, a scenario generation template 500 generates various scenarios by associating activity concepts 510 where contexts of respective activities of stakeholders are modified.

That is, each of the activities 520 includes an activity concept 510 based on a different context, and a scenario can be generated by selecting a specific activity concept 510 from each activity 520 and associating (or combining) them. Therefore, modeling of a new activity can be carried out by generating a scenario in which various activities are mapped in sequence, and the scenario generation template 500 can be used to implement an activity display system depending on a context.

The respective elements depicted in FIGS. 6 to 12 are configured as “modules”. The “modules” imply software or hardware such as a FPGA (Field Programmable Gate Array) or an ASIC (Application Specific Integrated Circuit) and the modules perform predetermined functions. However, the modules are not limited to the software or the hardware. Each of the modules may be stored in an addressable storage medium or may be configured to implement one or more processors. The elements and functions of the modules can be combined with each other or can be divided.

Further, the storage unit 140 may include at least one of, but not limited to, a volatile memory device such as cache, a ROM (Read Only Memory), a PROM (Programmable ROM), an EPROM (Erasable Programmable ROM), an EEPROM (Electrically Erasable Programmable ROM), and a flash memory, a volatile memory device such as a RAM (Random Access Memory), or a storage medium such as a HDD (Hard Disk Drive) and a CD-ROM.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

What is claimed is:

1. A context-based activity modeling apparatus comprising:
an activity element input interface via which data about an activity element including one or more of activity information of an activity modeling target, activity subject information, object information, tool information, and context information are input;
a data mapping unit for mapping the data input via the activity element input interface based on relations therebetween; and
an activity modeling display unit that graphically displays the mapped data on a screen.

2. The context-based activity modeling apparatus of claim 1,
wherein the activity element input interface generates and stores one or more context classes including one or more fields and field values for describing the context information.

3. The context-based activity modeling apparatus of claim 2,
wherein the fields or the field values included in the context classes are edited via a selection by a user.

4. The context-based activity modeling apparatus of claim 2,
wherein the context classes with identical context information for describing different activity modelings are shared among the activity modelings.

5. The context-based activity modeling apparatus of claim 1,
wherein the activity element input interface includes an activity input module for inputting data of a goal of the target as the activity information.

6. The context-based activity modeling apparatus of claim 1,
wherein the activity element input interface includes an activity subject input module for inputting data of one or more of an active actor, a passive actor, and a third party actor as the activity subject information.

7. The context-based activity modeling apparatus of claim 1,
wherein the activity element input interface includes an object input module for inputting data of the object of the activity as the object information.

8. The context-based activity modeling apparatus of claim 1,
wherein the activity element input interface includes a tool input module for inputting data of a means for achieving a goal of the target as the tool information.

9. The context-based activity modeling apparatus of claim 1,
wherein the activity element input interface includes a context input module for inputting data of one or more of a goal context, a relevant structure context, a physical context, and a psychological context related to the target as the context information.

10. The context-based activity modeling apparatus of claim 1,
wherein the activity element input interface includes an event input module for additionally inputting event information of the activity modeling target, and
the event information causes a change in the activity in a specific context.

11. The context-based activity modeling apparatus of claim 1,
wherein the activity element input interface includes an environment input module for additionally inputting environment information where the activity modeling target is located, and
the environment information includes one or more of an indoor space, an outdoor space, and a virtual space.

12. The context-based activity modeling apparatus of claim 1,
wherein the data mapping unit maps the input data to each other based on the context information.

13. A context-based activity modeling method comprising:
(a) storing input data about an activity element including one or more of activity information of an activity modeling target, activity subject information, object information, tool information, and context information;
(b) mapping the stored data based on relations therebetween; and
(c) displaying graphically the mapped data on a screen.

14. The context-based activity modeling method of claim 13,
wherein the step (a) includes one or more of storing data of a goal of the target as the activity information,
storing data of one or more of an active actor, a passive actor, and a third party actor as the activity subject information,
storing data of the object of the activity as the object information,
storing data of a means for achieving a goal of the target as the tool information, and
storing data of one or more of a goal context, a relevant structure context, a physical context, and a psychological context related to the target as the context information.

15. The context-based activity modeling method of claim 13,
wherein the step (a) includes storing an element that causes a change in the activity in a specific context as event information of the activity modeling target, and
storing data about one or more of an indoor space, an outdoor space, and a virtual space as environment information where the activity modeling target is located.

16. The context-based activity modeling method of claim 13,
wherein the step (b) includes mapping the stored data to each other based on the context information.

17. The context-based activity modeling method of claim 13,
wherein the step (a) includes generating and storing one or more context classes including one or more fields and field values for describing the context information.

18. The context-based activity modeling method of claim 17,
wherein the fields or the field values included in the context classes are edited via a selection by a user.

19. The context-based activity modeling method of claim 17,
wherein the context classes with identical context information for describing different activity modelings are shared among the activity modelings.
